(19) United States
(12) Patent Application Publication
(10) Pub. No.: US 2022/0232103 A1
(43) Pub. Date: Jul. 21, 2022

(54) INFORMATION PROCESSING SYSTEM, INFORMATION PROVISION SYSTEM, AND INFORMATION PROCESSING METHOD

(71) Applicant: SEIKO EPSON CORPORATION, Tokyo (JP)

(72) Inventor: Nobutada MIZUSAWA, SAPPORO-SHI TOYOHIRA-KU (JP)

(21) Appl. No.: 17/647,988

(22) Filed: Jan. 14, 2022

(30) Foreign Application Priority Data
Jan. 18, 2021 (JP) 2021-005565

(51) Int. Cl. H04L 67/75; H04L 67/55; G06F 3/04817

(52) U.S. Cl. CPC H04L 67/36; G06F 3/04817; H04L 67/26

(57) ABSTRACT

An information processing system includes a communication section and a processing section. The communication section is used to communicate, through a network, with a collection target apparatus and a terminal device capable of using an application that manages and displays status associated information of the collection target apparatus. The communication section obtains status associated information including an event that occurs in the collection target apparatus. The processing section performs a process of generating display screen information of the status associated information that is displayed by the application activated when link information is selected in the terminal device and that is specified by the link information. Furthermore, the communication section transmits the display screen information to the terminal device.

The present application is based on, and claims priority from JP Application Serial Number 2021-005565, filed Jan. 18, 2021, the disclosure of which is hereby incorporated by reference herein in its entirety.

### BACKGROUND

### 1. Technical Field

The present disclosure relates to an information processing system, an information provision system, and an information processing method.

### 2. Related Art

In general, an information processing system that collects status information associated with operation states of a plurality of apparatuses connected to a network has been used. JP-A-2019-028757 discloses a method for receiving a notification about a collection target apparatus by means of a terminal device including a dedicated application installed therein used by a user located in a position far from the collection target apparatus.

However, the user may not recognize status information without activating the application even though receiving the notification about the collection target apparatus.

### SUMMARY

According to an aspect of the present disclosure, an information processing system includes a communication section configured to perform communication through a network with a collection target apparatus and a terminal device that uses an application for managing and displaying status associated information of the collection target apparatus and a processing section. The communication section obtains the status associated information including an event that occurs in the collection target apparatus. The processing section performs a process of generating display screen information of the status associated information that is displayed by the application activated when link information is selected in the terminal device and that is specified by the link information. The communication section transmits the display screen information generated by the generation process to the terminal device.

According to another aspect of the present disclosure, an information provision system includes the information processing system, a first terminal device, and a second terminal device that is the terminal device. The first terminal device transmits the link information to the second terminal device.

According to a further aspect of the present disclosure, a program causes a terminal device to execute receiving link information for displaying display screen information of the status associated information including an event generated in the collection target apparatus, activating the application specified by the link information, receiving, by the activated application, the display screen information from the information processing system, and displaying the display screen information.

According to a still further aspect of the present disclosure, an information processing method includes performing communication through a network with a collection target apparatus and a terminal device that uses an application for managing and displaying status associated information of the collection target apparatus, obtaining the status associated information including an event that occurs in the collection target apparatus, generating display screen information of the status associated information that is displayed by the application activated when link information is selected in the terminal device and that is specified by the link information, and transmitting the display screen information to the terminal device.

### BRIEF DESCRIPTION OF THE DRAWINGS

FIG. 1 is a block diagram illustrating an example of a configuration of an information provision system.

FIG. 2 is a diagram illustrating an example of screens of an application.

FIG. 3 is a diagram illustrating an example of a flow of a process according to an embodiment.

FIG. 4 is a block diagram illustrating an example of the configuration of the information provision system in detail.

FIG. 5 is a diagram illustrating problems in a reference example.

FIG. 6 is a flowchart of an example of a first application process.

FIG. 7 is a flowchart of an example of a shared information process.

FIG. 8 is a flowchart of an example of a second application process.

FIG. 9 is a flowchart of an example of a reception process.

FIG. 10 is a flowchart of an example of a transmission process.

FIG. 11 is a diagram illustrating a flow of another process according to this embodiment.

FIG. 12 is another diagram illustrating the flow of the other process according to this embodiment.

FIG. 13 is still another diagram illustrating the flow of the other process according to this embodiment.

FIG. 14 is a further diagram illustrating the flow of the other process according to this embodiment.

FIG. 15 is a diagram illustrating a flow of a process according to a modification of this embodiment.

FIG. 16 is a flowchart of an example of a payload generation process.

FIG. 17 is a flowchart of an example of a URL generation process.

### DESCRIPTION OF EXEMPLARY EMBODIMENTS

Hereinafter, an embodiment will be described. Note that the embodiment below does not unreasonably limit content of the present disclosure disclosed in claims. It is not necessarily the case that all components described in this embodiment are requirements of the present disclosure.

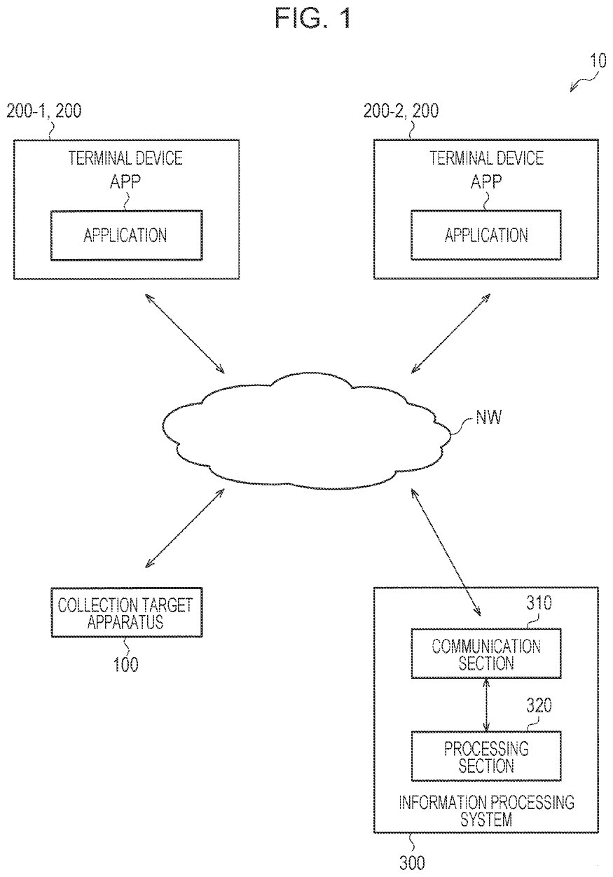

FIGS. 1 to 3 are diagrams illustrating a basic configuration of this embodiment. FIG. 1 is a block diagram illustrating an example of a configuration of an information provision system 10 according to this embodiment. As illustrated in FIG. 1, the information provision system 10 of this embodiment includes a collection target apparatus 100, terminal devices 200, and an information processing system 300. The number of terminal devices 200 is not limited to 2 as illustrated in the example of FIG. 1, and the information provision system 10 may include terminal devices 200-1 to 200-N. N is an integer not less than 2. Hereinafter, the terminal devices 200-1 and 200-2 are collectively referred to as a “terminal device 200” where appropriate. Similarly, the number of collection target apparatuses 100 is not limited to 1 as illustrated in the example of FIG. 1, and a plurality of collection target apparatuses 100 may be connected.

Although the collection target apparatus 100 is a printer, for example, the collection target apparatus 100 may be a personal computer, a wearable apparatus, a biological information measuring apparatus, a robot, a video apparatus, a physical quantity measuring apparatus, or the like. Note that examples of the wearable apparatus include a smart watch and an activity tracker. Furthermore, examples of the biological information measuring apparatus include a pulse monitor and a pedometer. Examples of the video apparatus include a camera and a projector. Examples of the physical quantity measuring apparatus include a thermometer and a weight scale. Moreover, the printer described herein includes a multifunction peripheral. The multifunction peripheral is a printer including functions other than a printer function, and the functions other than a printer function include a copy function, a facsimile function, and a scanner function. However, other functions may be included.

The collection target apparatus 100 may transmit status associated information to an outside. The status associated information indicates a state of the collection target apparatus 100 in a predetermined format.

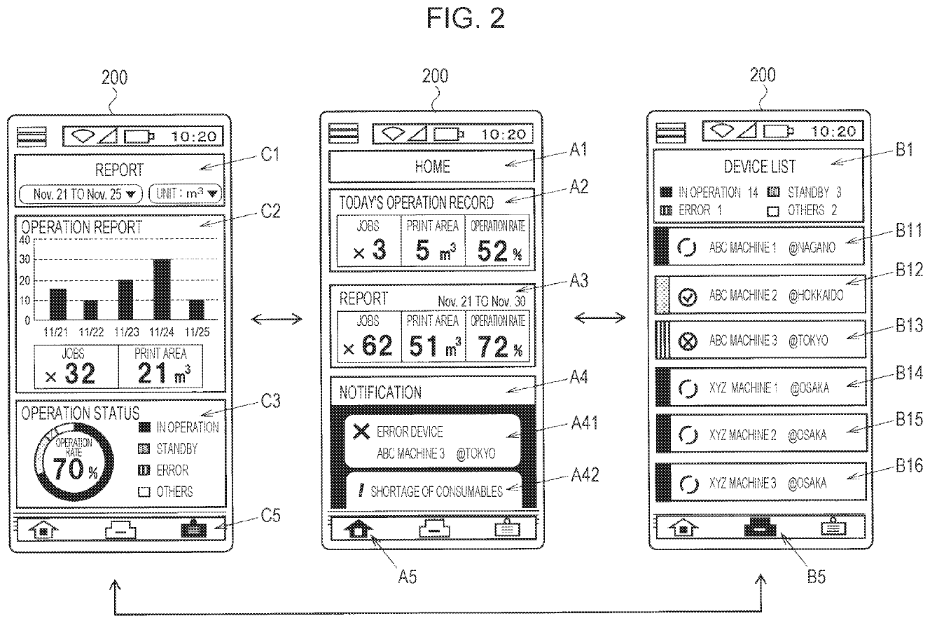

Specifically, although described hereinafter with reference to FIG. 2, the status associated information indicates “standby” in a non-operation state, “operating” in operation, and “error” when an error occurs. Furthermore, when the collection target apparatus 100 is in operation, information on an operation status is also included in the status associated information. Examples of the information on an operation status include the number of times a job is executed, an operation amount, and an operation rate. The operation amount indicates an amount of printing when the collection target apparatus 100 is a printer and is represented by a level of print area. Furthermore, when the collection target apparatus 100 is in an error state, content of an error or the like is also included in the status associated information. Here, examples of the error include a shortage of consumables, in addition to mechanical failure of the collection target apparatus 100. The shortage of consumables indicates an amount of remaining consumables not larger than a predetermined value, and execution of a job is not concerned. Assuming that the collection target apparatus 100 is a printer, when an amount of remaining ink or an amount of remaining toner is not larger than a predetermined amount, the printer is controlled to transmit an error signal from a sensor that detects the amount of remaining ink or the amount of remaining toner before a job is executed, whereas when transport of a print medium, such as a sheet, is interrupted, an error occurs during execution of the job.

Although the terminal device 200 is a mobile information terminal, such as a smartphone, the terminal device 200 may be a personal computer or the like. The terminal device 200 of this embodiment has an application APP installed therein that is an application program. The application APP is software that manages and displays the status associated information of the collection target apparatus 100. A function of the application APP may be realized by a terminal device processing section, not illustrated. An example of the realization of the function of the application APP will be described below in detail with reference to FIG. 2.

The information processing system 300 includes a communication section 310 and a processing section 320. The communication section 310 is used to communicate, through a network NW, with the collection target apparatus 100 and the terminal device 200 capable of using the application APP that manages and displays the status associated information of the collection target apparatus 100. The communication section 310 is a communication interface that is connected to an external apparatus in a communication available manner through the network NW. The communication interface may be realized by a solo semiconductor device having a communication function based on a predetermined communication standard. However, the communication interface may be realized as a portion of a function of a semiconductor device having other functions. The semiconductor device is a communication integrated circuit (IC), for example. Note that, although examples of the predetermined communication standard include wired communication standards, such as Ethernet (registered trademark) and a universal serial bus (USB), and wireless communication standards, such as Wi-Fi (registered trademark), other communication standards may be employed. Furthermore, when the predetermined communication standard is a wireless communication standard based on Wi-Fi (registered trademark) described above, wireless communication is realized through an access point, not illustrated. Specifically, the access point, not illustrated, periodically transmits wireless communication electric waves, such as beacon waves, so that identification information of the access point may be decoded.

Furthermore, the identification information of the access point is a service set identifier (SSID), for example. Moreover, when the information processing system 300 receives electric waves from a user access point of the collection target apparatus 100, the user inputs a predetermined password to the information processing system 300 so that the information processing system 300 may be connected to the access point. Furthermore, when the information processing system 300 is to be connected again to the same access point, the user may cause the information processing system 300 to be automatically connected to the access point without inputting the password. The access point may also be referred to as a “router”. In this embodiment, a “communication connection based on a communication standard” is simply referred to as a “connection” where appropriate.

Note that, although not illustrated, the collection target apparatus 100 and the terminal device 200 also have the same communication interface based on the predetermined communication standard as the communication section 310. In other words, since each of the collection target apparatus 100, the terminal device 200, and the information processing system 300 includes a semiconductor device having a communication function based on a predetermined communication standard, mutual communication may be realized through the network NW. Furthermore, a user of the terminal device 200 transmits data including identification information unique to the terminal device 200 to the collection target apparatus 100 and the information processing system 300. Examples of the identification information unique to the terminal device 200 include an IP address and a MAC address. Therefore, even when a plurality of terminal devices 200 belong to the access point, not illustrated, the plurality of terminal devices 200 may be distinguished from each other.

The processing section 320 controls the various sections included in the information processing system 300, such as the communication section 310. The processing section 320 is specifically a processor or a controller. The processing section 320 may include a plurality of CPUs, such as a main CPU and a sub CPU. The main CPU controls the sections included in the information processing system 300 and the entire information processing system 300. The sub CPU controls communication performed by the communication section 310, for example. Note that, when the information processing system 300 is a printer, a CPU that performs various processes associated with printing may be further included. The processing section 320 of this embodiment is configured by hardware described below. The hardware includes at least one of a circuit that processes digital signals and a circuit that processes analog signals. For example, the hardware is configured by at least one circuit device implemented on a circuit substrate or at least one circuit element. Note that examples of the circuit device include an integrated circuit device. Furthermore, examples of the circuit element include an active element, such as a transistor, and a passive element, such as a resistor or a capacitor.

Furthermore, the processing section 320 may be realized by a processor below. The information processing system 300 of this embodiment includes a memory, not illustrated, storing information and a processor operating based on the information stored in the memory. Note that examples of the information include programs, such as the application APP described above, and data, such as status associated information described below. The processor includes hardware. Furthermore, as the processor, various types of processor may be used, such as a central processing unit (CPU), a graphics processing unit (GPU), and a digital signal processor (DSP). Moreover, the memory herein may be a semiconductor memory, such as a static random access memory (SRAM) or a dynamic random access memory (DRAM), a register, a magnetic storage device, such as a hard disk device, or an optical storage device, such as an optical disc device. In addition, the memory stores computer-readable instructions, for example, and functions of the processing section 320 are realized as processes when the processor executes the instructions. The instructions may be instructions of an instruction set constituting a program or instructions indicating an operation to a hardware circuit of the processor, or a portion of or the entire processing section 320 may be realized by cloud computing. Note that, although omitted in the figure, the collection target apparatus 100 described above also includes a processor similar to the processing section 320 so as to realize a function of a collection-target-apparatus processing section. Similarly, the terminal device 200 also includes a processor similar to the processing section 320 so as to realize a function of a terminal-device processing section. Note that, in a description below, a process performed by the collection-target-apparatus processing section of the collection target apparatus 100 is simply referred to as a process performed by the collection-target-apparatus processing section where appropriate, and a process performed by the terminal-device processing section of the terminal device 200 is simply referred to as a process performed by the terminal-device processing section where appropriate.

FIG. 2 is a diagram illustrating an example of a screen of the application APP described above. When the terminal device 200 activates the application APP, for example, a login screen, not illustrated, is displayed. The screen of the terminal device 200 is a touch panel, and the user may view a home screen indicated by A1 by inputting a user ID and a user password on the login screen by means of a touch panel operation. The user ID and the user password are identification information assigned to each user. Furthermore, the user may perform switching between a device list screen indicated by B1 and a report screen indicated by C1 in addition to the home screen described above by selecting a predetermined icon. Examples of the predetermined icon include icons indicated by A5 to C5, for example, and the user may perform switching to an associated screen by selecting another icon. When the user selects an icon associated with a report indicated by A3 described below, for example, the report screen indicated by C1 may be entered, or when the user selects an icon associated with an error indicated by A41 described below, for example, the device list screen indicated by B1 may be entered.

The home screen indicated by A1 comprehensively displays information on the collection target apparatus 100 including information on an operation status on the day indicated by A2, information on an operation status in a past predetermined period of time indicated by A3, and information on an event that currently occurs indicated by A4. Examples of the event described herein include an event associated with occurrence of an error indicated by A41, an event associated with shortage of an amount of remaining consumptions indicated by A42, and others. Note that a number of or all images indicated by A2, A3, A4, A41 and A42 may be formed as image icons, and the user may open a detailed screen by selecting one of the image icons. Furthermore, although not illustrated, the home screen may be scrolled so that information other than the information indicated by A2 to A4 may be displayed. The same is true of the device list screen and the report screen.

The device list screen indicated by B1 displays a list of collection target apparatuses 100 connected to the information processing system 300. Although, among all the collection target apparatuses 100 connected to the information processing system 300, apparatuses in operation, apparatuses in a standby state, and apparatuses in an error state may be recognized in the device list screen, apparatuses in other states may be displayed. Examples of the other states include a state in which a failure occurs in communication connection, for example. Furthermore, in the device list screen, as indicated by B11 to B16, individual states of the collection target apparatuses 100 may be recognized. Furthermore, a number of or all images indicated by B11 to B16 may be formed as icons, and the user may open a detailed screen by selecting one of the image icons. For example, when the user selects an icon “ABC machine 3” that is indicated by B13 and represented as an error machine, a screen indicating detailed information of the error may be further opened in the device list screen as the status associated information, although not illustrated. The detailed information of the error indicates a time point when the error occurred, an error code that is identification information of the error, or the like.

A report screen indicated by C1 represents an operation record and an operation status, for example, by a graph or the like in detail. In the operation record indicated by C2, a period of time and a unit may be selected. Specifically, when the user changes a period of time by selecting a period of time included in C1, a graph indicated by C2 in the report screen also changes in accordance with the change in the period of time. The operation status indicated by C3 represents a current operation status. Note that the report screen may be changed to the device list screen indicated by B1 when the user selects the icon indicated by C3.

Furthermore, link information, such as a hyperlink, may be set to a top page illustrated in FIG. 2. Moreover, link information that may specify individual content included in the screen examples in FIG. 2 may be set. For example, when the user clicks a hyperlink displayed in a predetermined mail software screen installed in the terminal device 200, the application APP is activated and screen information specified by the hyperlink is opened.

Note that an example of the screen of the application APP in FIG. 2 is merely an example, and a specification of the screen is not limited to that illustrated in FIG. 2. That is, various modifications may be made including addition of other icons and deletion of a number of the icons described above.

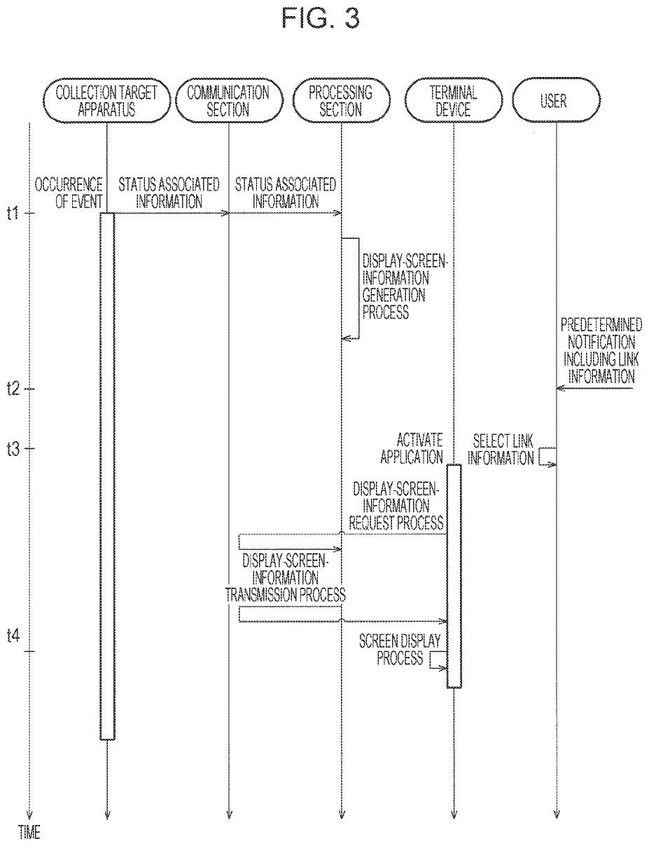

FIG. 3 is a diagram illustrating a flow of a process according to this embodiment. When an event occurs in the collection target apparatus 100 at a timing t1, the collection target apparatus 100 transmits status associated information to the processing section 320 through the communication section 310 of the information processing system 300. The event herein is an error of the collection target apparatus 100 indicated by A41 in FIG. 2, for example. Then the processing section 320 performs a display-screen-information generation process based on the status associated information received by the communication section 310. The display screen information generated by the display-screen-information generation process is data in a hypertext markup language (html) format, for example. The application APP may generate image data that may be displayed in the terminal device 200 by performing a rendering process for display on the data in the html format.

At a timing t2 that comes after the timing t1, the user of the terminal device 200 receives a certain notification including link information from another user not illustrated. Here, the certain notification is associated with the error of “ABC machine 3” indicated by A41 in FIG. 2. In the certain notification, for example, a uniform resource locator (URL) that is link information on a direct link to a screen displaying the detailed information of the error of “ABC machine 3” described above is displayed in the predetermined mail software screen installed in the terminal device 200. Specifically, the link information herein indicates a link capable of entering a specific screen of the application APP, that is, a so-called deep link.

When the user selects the link information that is the deep link at a timing t3 that comes after the timing t2, the application APP of the terminal device 200 is activated and the application APP performs a display-screen-information request process. Specifically, the terminal device processing section transmits a request for display-screen-information associated with the link information to the processing section 320 through the communication section 310. Then the processing section 320 that receives the display-screen-information request performs a display-screen-information transmission process. Specifically, the processing section 320 transmits the display screen information in the html format described above corresponding to the display-screen-information request process through the communication section 310. Then the terminal device processing section of the terminal device 200 receives the display screen information through the communication interface not illustrated. Note that, in a description below, transmission and reception performed by the processing section 320 of the information processing system 300 through the communication section 310 is referred to as “transmission and reception of the communication section 310” where appropriate.

At a timing t4 that comes after the timing t3, the terminal device 200 performs a screen display process. Specifically, the application APP generates detailed screen information to be displayed in the terminal device 200 by performing the rendering process on the html data transmitted by the display-screen-information transmission process performed by the processing section 320 so as to display the screen information in the terminal device 200. In this way, the user receives the link information that is the deep link so as to directly access a screen associated with “ABC machine 3” that is the collection target apparatus 100.

As described above, the information processing system 300 of this embodiment includes the communication section 310 and the processing section 320. The communication section 310 is used to communicate with the collection target apparatus 100 and the terminal device 200 capable of using the application APP that manages and displays the status associated information of the collection target apparatus 100 through the network NW. Furthermore, the communication section 310 obtains status associated information including an event generated in the collection target apparatus 100. The processing section 320 performs a process of generating display screen information of the status associated information that is displayed by the application APP activated when link information is selected in the terminal device 200 and that is specified by the link information. Furthermore, the communication section 310 transmits the display screen information generated by the generation process to the terminal device 200.

As described above, since the information processing system 300 includes the communication section 310 and the processing section 320 that enable communication between the collection target apparatus 100 and the terminal device 200 through the network, the information processing system 300 may function as an information processing system that transmits an information processing result collected from the collection target apparatus 100 to the terminal device 200. Furthermore, the processing section 320 generates display screen information to be displayed by the application APP installed in the terminal device 200, and the application APP is automatically activated when link information displayed in the terminal device 200 is selected, and therefore, the user may save a step of activating the application APP.

Furthermore, this embodiment may be realized as a program. Specifically, the program of this embodiment is the status associated information collected by the information processing system 300 and causes the terminal device 200 to execute a step of receiving link information for displaying display screen information of the status associated information including an event generated in the collection target apparatus 100 and a step of activating the application APP specified by the link information. Furthermore, the activated application APP causes the terminal device 200 to execute a step of receiving the display screen information from the information processing system 300 and a step of displaying the display screen information. In this way, effects the same as those described above may be attained.

Furthermore, this embodiment may be realized as an information processing method. Specifically, the information processing method of this embodiment performs a process of communicating with the collection target apparatus 100 and the terminal device 200 capable of using the application APP that manages and displays the status associated information of the collection target apparatus 100 through the network NW and a process of obtaining the status associated information including the event generated in the collection target apparatus 100. Furthermore, the information processing method of this embodiment performs a process of generating display screen information of the status associated information that is to be displayed by the application APP activated when link information is selected in the terminal device 200 and that is specified by the link information and a process of transmitting the display screen information to the terminal device 200. In this way, effects the same as those described above may be attained.

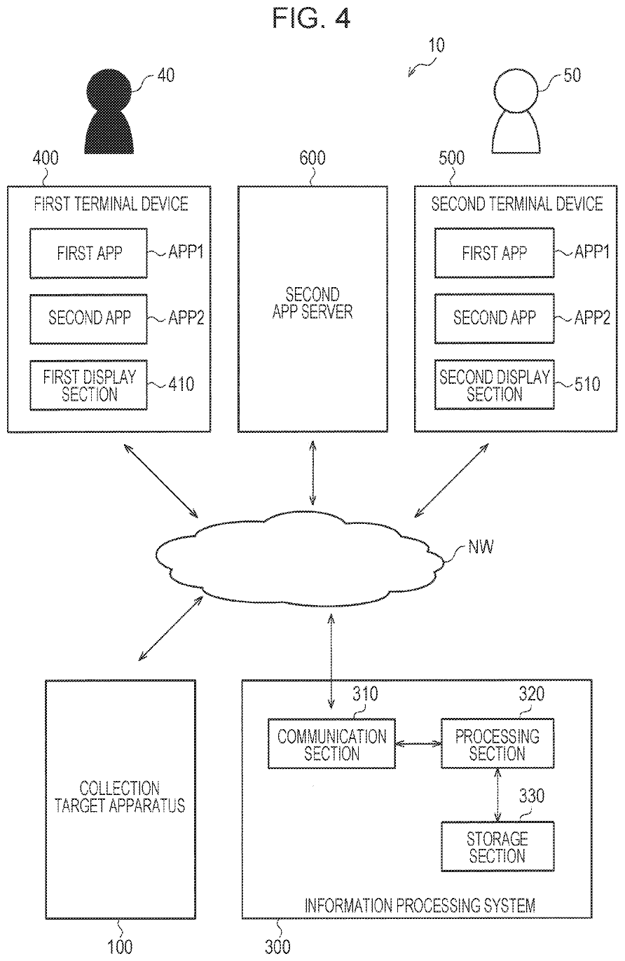

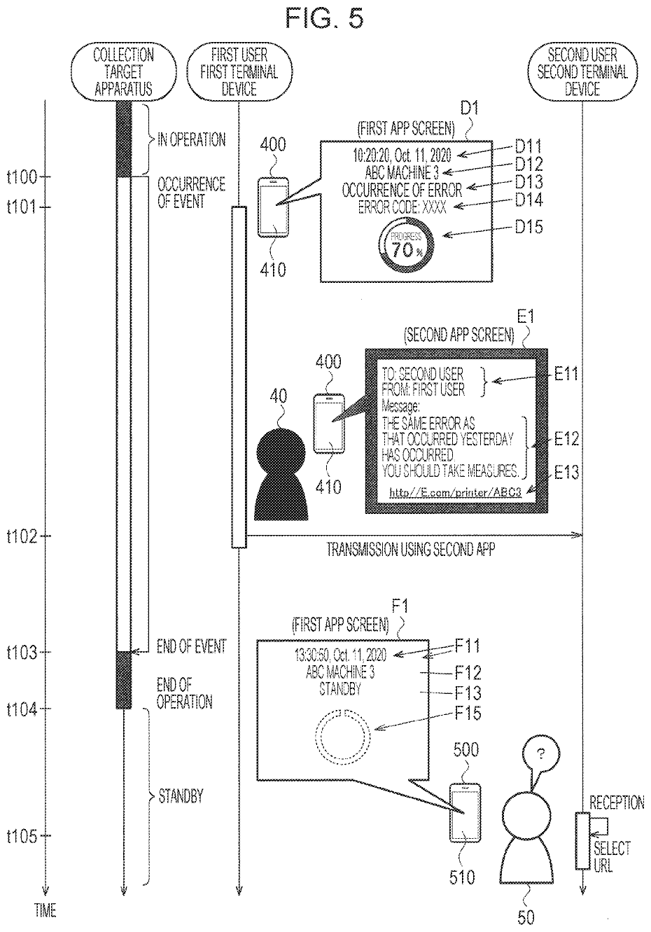

Note that the configuration of the information provision system 10 of this embodiment is not limited to that illustrated in FIG. 1, and various modifications may be made by omitting a number of the components or adding other components, for example. The image provision system 10 may be configured as illustrated in FIG. 4, for example. The information provision system 10 of FIG. 4 includes, in addition to the collection target apparatus 100 and the information processing system 300 described with reference to FIG. 1, a first terminal device 400 owned by a first user 40, a second terminal device 500 owned by a second user 50, and a second application server 600. The information processing system 300 of FIG. 4 includes, in addition to the communication section 310 and the processing section 320 described with reference to FIG. 1, a storage section 330. The first terminal device 400 includes a first display section 410 and has a first application APP and a second application APP2 installed therein. Similarly, the second terminal device 500 includes a second display section 510 and has the first application APP and the second application APP2 installed therein. Note that, in FIG. 4, the “first application” is simply described as a “first APP” and the “second application” is simply described as a “second APP” where appropriate. The same is true of FIGS. 5, 6, 8, 12, 13, and 14 described below.

Note that the collection target apparatus 100, the communication section 310, and the processing section 320 in FIG. 4 are the same as those illustrated in FIG. 1, and therefore, descriptions thereof are omitted. Furthermore, the first terminal device 400 and the second terminal device 500 in FIG. 4 correspond to the terminal device 200 in FIG. 1, and the first application APP1 in FIG. 4 corresponds to the application APP in FIG. 1. Therefore, descriptions thereof are omitted herein. Moreover, although the number of users is 2 in the example of FIG. 4, the number of users may be expanded to N, and one user may own a plurality of terminal devices. Furthermore, as with the example of FIG. 1, three or more users may be connected, three or more terminal devices may be connected, and a plurality of collection target apparatuses may be connected also in the example of FIG. 4.

The storage section 330 is configured by a storage medium, such as an HDD, a ROM, or a RAM, and stores information received from the collection target apparatus 100 through the communication section 310. Specifically, the information indicates operation information periodically received by the communication section 310 from the collection target apparatus 100 and information on an event irregularly generated. The information processing system 300 successively obtains information from a plurality of collection target apparatuses 100, and therefore, information is stored in the storage section 330 such that each information is associated with identification information for identifying the information. Examples of the identification information herein include an identifier (ID) for identifying one of the collection target apparatuses 100, time point information associated with an operation status of the collection target apparatus 100 or an event, and event identification information for identifying an event. Examples of the event identification information include an error code when the event indicates an error.

Note that the time point information herein may be represented by a number having the predetermined number of digits based on information on an hour, a minute, a second, and so on. For example, when an event is generated at “10:20:20 in Oct. 11, 2020”, the time point information may be represented by a number of 14 digits “10202010112020”. Furthermore, when the time point information may be obtained in a smaller time unit, such as a millisecond, the time point information may be a number of the further increased number of digits, that is, various modifications may be made.

Although not illustrated, the processing section 320 may perform a process of rearranging and a process of re-searching on the operation information, the event information, and the like stored in the storage section 330. Specifically, the processing section 320 may perform a process of rearranging in an ascending order of time point and a process of re-searching on a series of status associated information stored in the storage section 330 based on associated time point information.

The first display section 410 is constituted by a display that displays various information for the user. Specifically, the first display section 410 may be realized by a liquid crystal display, for example, and may be realized by an organic electroluminescence (EL) display or the like. When the first user 40 activates the first application APP1, the screen illustrated in FIG. 2 as described above is displayed in the first display section 410. Note that the first display section 410 may also serve as an operation section, not illustrated in FIG. 4, that is, a touch panel. The description of the first display section 410 above is true of the second display section 510.

The second application APP2 supports share of information with the first application APP1. Although the second application APP2 is a mail application corresponding to an electronic mail, for example, the second application APP2 may be a messenger application that supports instant messages (IMs) or an application that supports short message services (SMSs). The first user 40 and the second user 50 may communicate with each other by messages and attach another binary data using the second application APP2.

The second application server 600 stores a message transmitted or received by the second user 50 of the second application APP2. When the first user 40 generates a message, for the second user 50, using the second application APP2 of the first terminal device 400, for example, data on the message is stored in the second application server 600, and thereafter, the second user 50 accesses the second application server 600 using the second application APP2 of the second terminal device 500 and reads the stored message data. In this way, transmission of the message is completed. Note that, although the server for transmission and a server for reception are collectively illustrated in FIG. 4, the server for transmission and the server for reception may be individually provided.

Furthermore, although the method for sharing screen information associated with the status associated information of the collection target apparatus 100 between different users is described above, the sharing method is not limited to that described above. The information provision system 10 may allow different users to share information on a time point when an event is generated, that is, time stamp information. Since the time stamp information is shared as described above, the first user 40 and the second user 50 may share the same status associated information even when the first user 40 and the second user 50 open the first application APP1 in different time points, and accordingly, certain inconvenience may be avoided. The certain inconvenience will be described hereinafter with reference to a reference example of FIG. 5.

Referring to FIG. 5, a reference example of a flow of a process for explaining problems that arise when the time stamp information is not shared will be described. It is assumed that an event occurs at a timing t100 in the collection target apparatus 100 in operation. The event here is associated with an occurrence of an error due to a failure of the collection target apparatus 100, for example. It is assumed that, at the timing t100, the first user 40 and the second user 50 do not activate the first application APP1 and do not recognize the occurrence of the event. Although not illustrated in FIG. 5, the processing section 320 generates display screen information through the status-associated-information transmission process and the display-screen-information generation process described with reference to FIG. 3.

At a timing t101 that comes after the timing t100, when activating the first application APP1, the first user 40 recognizes screen information associated with the event of the collection target apparatus 100 as indicated by screen information D1. The screen information indicated by D1 includes information on a time point when the event has occurred indicated by D11, identification information of the collection target apparatus 100 that is a target of the event indicated by D12, information indicating content of the event indicated by D13, and identification information of the event indicated by D14. It is assumed that the identification information of the event herein indicates an error code. Furthermore, as indicated by D15, information on an operation of the collection target apparatus 100 at the time point when the event occurs may be displayed, for example. The information on an operation indicates a degree of progress of printing when the collection target apparatus 100 is a printer, for example.

Note that “10:20:20, Oct. 11, 2020” indicated by D11 in the screen information D1 corresponds to the timing t100, and “ABC machine 3” indicated by D12 corresponds to the collection target apparatus 100.

The first user 40 activates the second application APP2 and inputs content illustrated in the screen information E1 so as to notify the second user 50 of content of the screen information D1. Although the content specifically includes header information indicated by E11, message information indicated by E12, and link information indicated by E13, other information may be included. The link information indicated by E13 is a deep link as described above, and when the link information is selected, the first application APP1 is activated and status information of “ABC machine 3” indicated by D12 may be viewed. Subsequently, at a timing t102 that comes after the timing t101, the first user 40 completes the operation of transmission to the second user 50. It is assumed that the second user 50 may not yet use the second terminal device 500 at the timing t102.

Thereafter, the second user 50 recognizes a message sent by the first user 40 when activating the second application APP2 of the second terminal device 500. Then the second user 50 views the same screen information, not illustrated, as the screen information E1 using the second display section 510. Subsequently, when a URL that is the link information indicated by E13 is selected at a timing t105 that is later than the timing t102, the first application APP1 of the second terminal device 500 is activated.

When the event that occurred at the timing t100 described above is continued at the timing t105, the second user 50 may view the same screen information as the screen information D1. However, the same event may not be continued. As illustrated in FIG. 5, for example, it is assumed that the event is terminated at a timing t103 that comes later than the timing t102 and earlier than the timing t105. The termination of the event is specifically termination of the error due to fixing of the failure of the collection target apparatus 100 or the like. Furthermore, it is also assumed that the operation of the collection target apparatus 100 is terminated at a timing t104 that comes later than the timing t103 and earlier than the timing t105.

In this case, when the second user 50 selects the URL that is the link information indicated by E13, screen information indicated by F1 is displayed. Specifically, selection of the URL by the second user 50 at the timing t105 corresponds to a request, to the information processing system 300, of a transmission of the screen information F1 based on the status associated information stored at a timing immediately before the timing t105. Therefore, the information processing system 300 returns the screen information F1 based on the status associated information stored at the timing immediately before the timing t105, and the second user 50 views the screen information F1. Note that “13:30:50, Oct. 11, 2020” indicated by F11 corresponds to the timing immediately before the timing t105.

Therefore, the screen information F1 displays the time point information indicated by F11, identification information of the collection target apparatus 100 indicated by F12, and information on content of a status indicated by F13 and F15. For example, the information on content of a status indicated by F13 and F15 represents that the collection target apparatus 100 is in a standby state, and therefore, does not match the description of the error included in the message indicated by E12 described above. Accordingly, the second user 50 may not understand intention of the message transmitted from the first user 40.

In this way, since the case described with reference to FIG. 5 may occur, the first user 40 and the second user 50 may share time stamp information that enables share of the same status associated information when the first user 40 and the second user 50 open the first application APP1 in different time points according to the method of this embodiment. Hereinafter, a processing example and the like for realizing the method will be described.

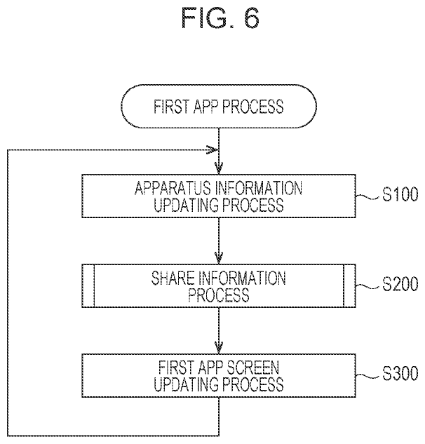

Examples of a process performed by the terminal device processing section of the first terminal device 400 and a process performed by the terminal device processing section of the second terminal device 500 will be described with reference to flowcharts in FIGS. 6 to 10. Note that, in a description below, a process performed by the terminal device processing section of the first terminal device 400 and a process performed by the terminal device processing section of the second terminal device 500 are simply referred to as a process performed by the terminal device processing section.

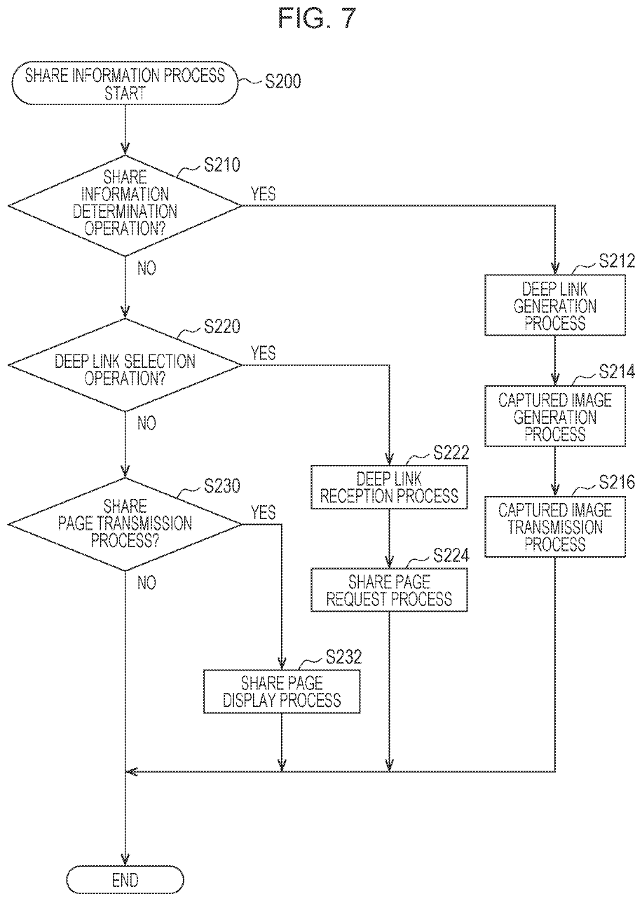

FIG. 6 is the flowchart of an example of a process performed by the first application APP1. In the first application process, an apparatus information updating process (step S100), a share information process (step S200), and a first application screen updating process (step S300) are repeatedly performed. The share information process (step S200) will be described in detail hereinafter with reference to FIG. 7. Although detailed illustration of the apparatus information updating process (step S100) is omitted, the apparatus information updating process includes a process of requesting the information processing system 300 to transmit latest status information of the collection target apparatus 100 and a process of requesting the information processing system 300 to update the status information where appropriate. In the first application screen updating process (step S300), a browser screen of the first application APP1 is updated in accordance with the apparatus information updating process (step S100) and the share information process (step S200).

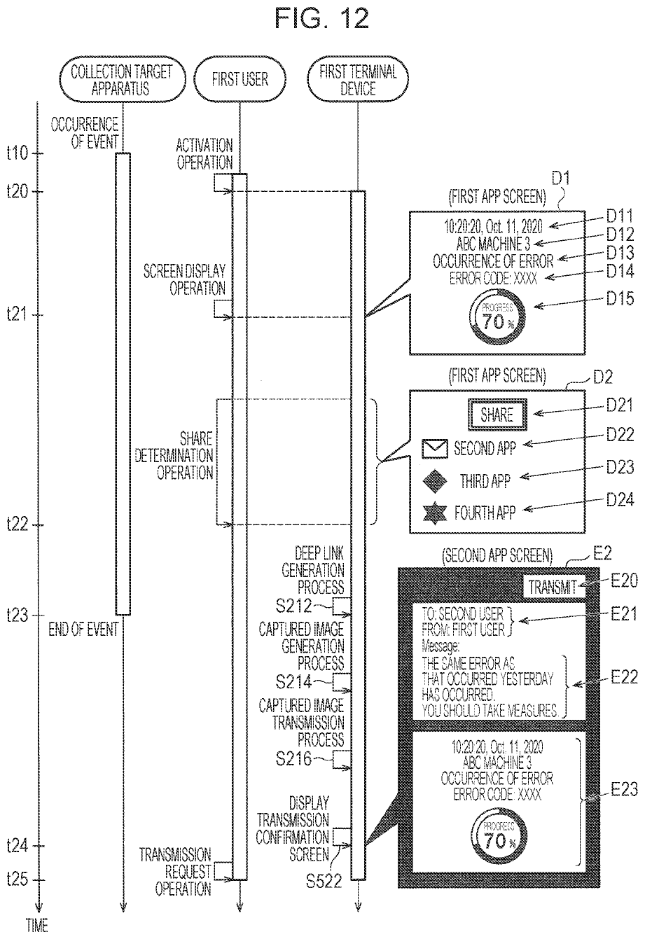

FIG. 7 is a flowchart of an example of the share information process (step S200). The share information process (step S200) is associated with transmission and reception of share information described below. The terminal device processing section determines whether a share information setting operation has been performed. When the share information setting operation has been performed (YES in step S210), a deep link generation process (step S212), a captured image generation process (step S214), and a captured image transmission process (step S216) are performed before the flow is terminated. The share information setting operation will be described hereinafter with reference to FIG. 12.

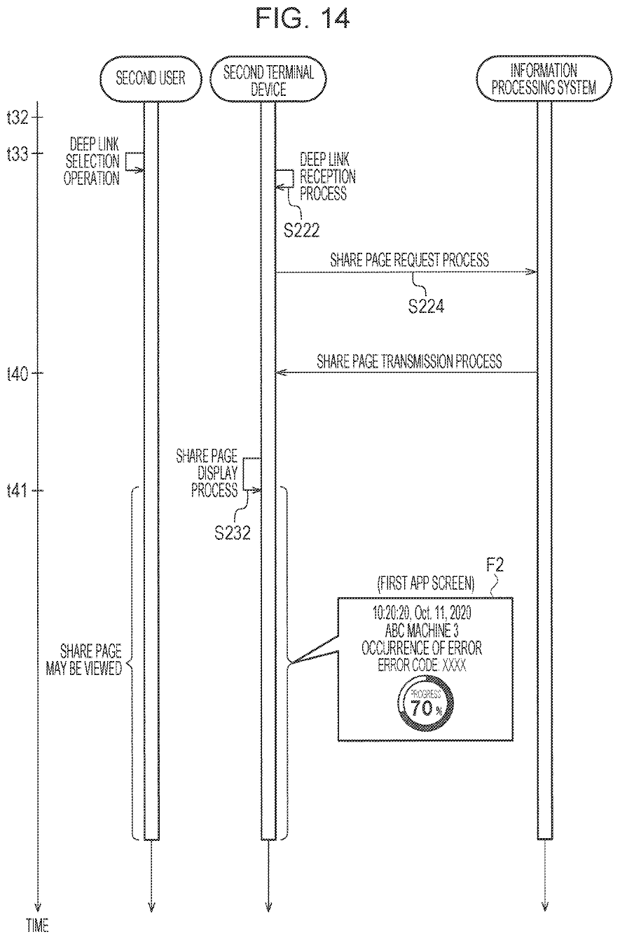

The terminal device processing section determines whether a deep link selection operation has been performed when the share information setting operation has not been performed (NO in step S210). When the deep link selection operation has been performed (YES in step S220), a deep link reception process (step S222) and a share page request process (step S224) are performed before the flow is terminated. The deep link selection operation will be described hereinafter with reference to FIG. 14.

The terminal device processing section determines whether a share page transmission process has been performed when the deep link selection operation is not performed (NO in step S220). When the share page transmission process has been performed (YES in step S230), a share page display process (step S232) is performed before the flow is terminated. The share page transmission process will be described hereinafter with reference to FIG. 14. When the share page transmission process has not been performed (NO in step S230), the terminal device processing section terminates the flow. In other words, when an operation associated with sharing or a request process is not performed, the share information process (step S200) is not particularly performed.

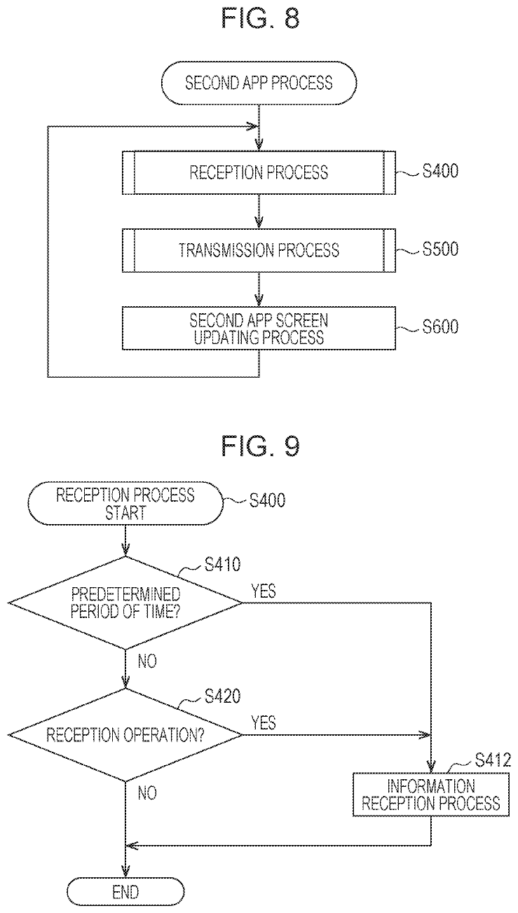

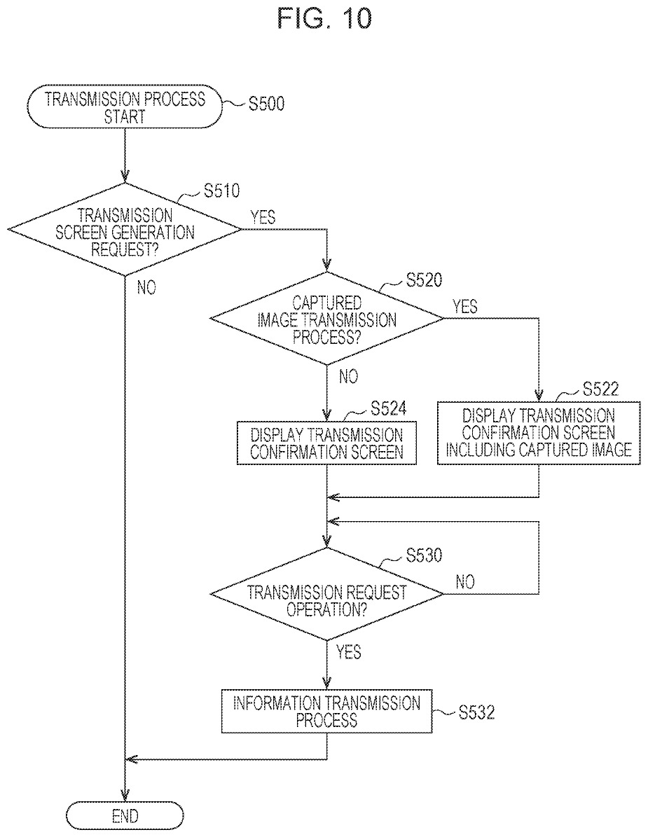

FIG. 8 is the flowchart of an example of a second application process. In the second application process, a reception process (step S400), a transmission process (step S500), and a second application screen updating process (step S600) are repeatedly performed. The reception process (step S400) will be described in detail hereinafter with reference to FIG. 9, and the transmission process (step S500) will be described in detail hereinafter with reference to FIG. 10. In the second application screen updating process (step S600), results of the reception process (step S400) and the transmission process (step S500) are reflected on a screen of a browser of the second application APP2.

FIG. 9 is the flowchart of an example of the reception process (step S400). The terminal device processing section performs a process of determining whether a predetermined period of time has elapsed. When the predetermined period of time has elapsed (YES in step S410), the terminal device processing section performs an information reception process (step S412) and terminates the flow. When the predetermined period of time has not elapsed (NO in step S410), the terminal device processing section performs a process of determining whether a reception operation has been performed. When the reception operation has been performed (YES in step S420), the terminal device processing section performs the information reception process (step S412) described above and terminates the flow. In the information reception process (step S412), specifically, data, such as a message, stored in the second application server 600 is read. Note that, when the reception operation has not been performed (NO in step S420), the flow is immediately terminated. Note that the user may freely set the predetermined period of time.

FIG. 10 is the flowchart of an example of the transmission process (step S500). The terminal device processing section performs a process of determining whether a transmission screen generation request has been issued. When the transmission screen generation request has been issued (YES in step S510), the terminal device processing section performs a process of determining whether the captured image transmission process (step S216) has been performed (step S520). When the captured image transmission process (step S216) has been performed (YES in step S520), the terminal device processing section performs a process of displaying a transmission confirmation screen including a captured image (step S522). When the captured image transmission process (step S216) has not been performed (NO in step S520), the terminal device processing section performs a process of displaying a transmission confirmation screen without a captured image (step S524). Thereafter, the terminal device processing section repeatedly performs a process of determining whether a transmission request has been issued. When a transmission request has been issued (YES in step S530), the terminal device processing section performs an information transmission process (step S532) and terminates the flow. In the information transmission process (step S532), specifically, data, such as a message, is transmitted to the second application server 600. Note that, although not illustrated, a process of cancelling transmission may be added after display of the transmission confirmation screen in the transmission process (step S500), and various modifications may be made.

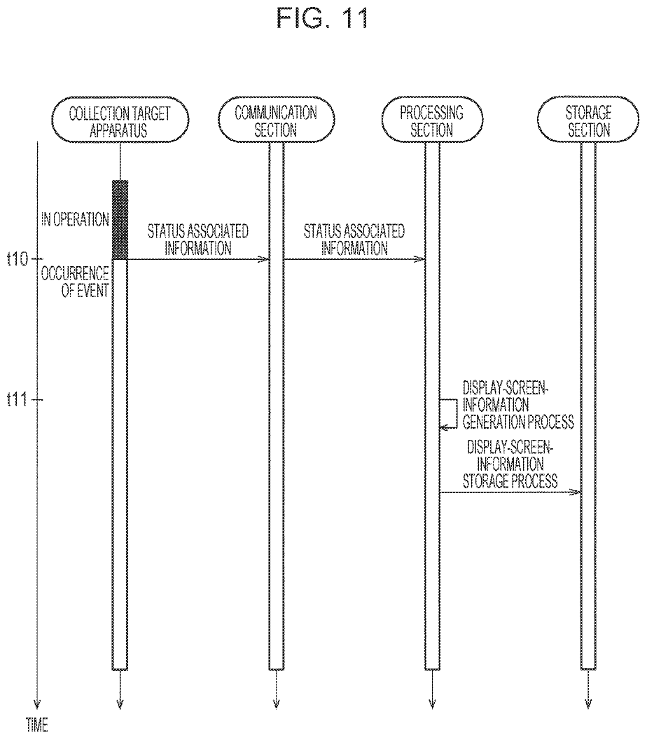

FIGS. 11 to 15 are diagrams illustrating a flow a process employing a method for sharing time stamp information according to this embodiment. It is assumed, in FIG. 11, that an event occurs at a timing t10 in the collection target apparatus 100 in operation. The event herein indicates an error similarly to FIGS. 3 and 5. As with FIG. 3, the collection target apparatus 100 transmits status associated information to the communication section 310. Furthermore, at a timing t11 that comes after the timing t10, the processing section 320 performs a display-screen-information generation process based on the status associated information received by the communication section 310, and in addition, performs a display-screen-information storage process. Although described hereinafter in detail, the collection target apparatus 100 specifically transmits a captured image of status information obtained when the event occurs to the communication section 310 as status associated information, and the processing section 320 generates the captured image by the display-screen-information generation process described above and stores the captured image associated with information on a time point when the event occurs in the storage section 330.

At a timing t20 in FIG. 12, the first application APP1 is activated in the first terminal device 400 when the first user 40 performs a process of activating the first application APP1. It is assumed that the timing t20 of FIG. 12 comes after the timing t10 and the timing t11 illustrated in FIG. 11.

At a timing t21 that comes after the timing t20, the first user 40 recognizes information on the event, performs a screen display operation associated with the event, and recognizes screen information D1 associated with the event. Note that the screen information D1 recognized at the timing t21 in FIG. 12 is the same as the screen information D1 illustrated in FIG. 5. Furthermore, the timing t10 illustrated in FIGS. 11 and 12 corresponds to “10:20:20, Oct. 11, 2020” similarly to the timing t100 illustrated in FIG. 5.

Subsequently, the first user 40 desires to share the screen information D1 with the second user 50, performs a share determination operation, and completes a share setting operation at a timing t22 that comes after the timing t21. Specifically, although not illustrated, the first user 40 performs a long press or the like on a predetermined portion in the first display section 410 where the screen information D1 is displayed, for example, so that a determination as to whether the screen information D1 is to be shared is displayed. When the first user 40 selects the share of the screen information D, a screen for selecting an application required for the sharing is displayed as represented by screen information D2. It is assumed, as the application to be used for the sharing, that the first user 40 selects the second application APP2. By this, the transmission screen generation request described above is issued to the second application APP2 in step S510 of FIG. 10.

Then the terminal device processing section of the first terminal device 400 individually performs the first application process and the second application process described above. The first application process will now be described in detail. Since the share setting operation is performed (YES in step S210) in accordance with the flowchart described with reference to FIG. 7, the deep link generation process (step S212), the captured image generation process (step S214), and the captured image transmission process (step S216) are performed.

Furthermore, the second application process will be described in detail. Since the transmission screen generation request is issued (YES in step S510) in accordance with the flowchart described with reference to FIG. 10 and the captured image transmission process (step S216) is performed, a process of displaying the transmission confirmation screen including the captured image is performed (step S522). Thereafter, at a timing t24 that comes later than the timing t22, the second application screen updating process (step S600) in FIG. 8, that is not illustrated in FIG. 12, is performed so that a screen indicated by screen information E2 is displayed in the first display section 410.

Note that, although the event of the collection target apparatus 100 is terminated at the timing t23 that comes after the timing t22 and before the timing t24 in FIG. 12 herein, the event may be terminated at a later timing, and specifically, the event may be terminated at any timing only before a timing t41 described hereinafter with reference to FIG. 14. In other words, the event is terminated at least at a timing before a timing when the second user 50 views a screen shared by the first user 40.

When comparing the screen information E2 of FIG. 12 with the screen information E1 of FIG. 5, although header information indicated by E21 is the same as that indicated by E11 of FIG. 5 and message information indicated by E22 is the same as that indicated by E12 of FIG. 5, a captured image indicated by E23 is additionally included in FIG. 12. The captured image indicated by E23 is the same as the image of the screen information D1.

Subsequently, at a timing t25 that comes after the timing t24, the first user 40 performs a transmission request operation. Specifically, the first user 40 performs an operation of selecting a transmission button icon indicated by E20 or the like.

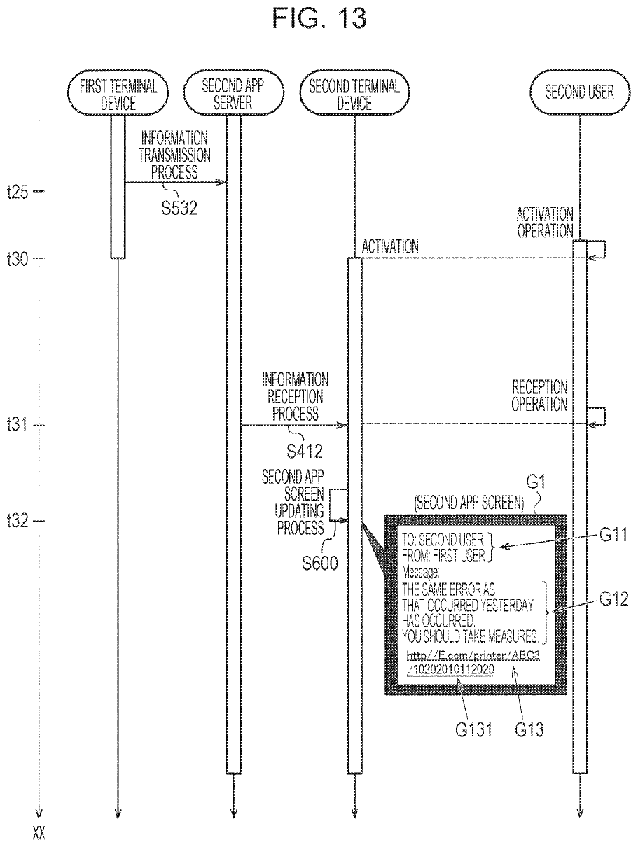

Referring to FIG. 13, the flow of the process will be continued. Since the transmission request operation is performed at the timing t25, the terminal device processing section of the first terminal device 400 performs an information transmission process so as to correspond to step S532 of FIG. 10. Specifically, transmission data is transmitted to the second application server 600.

It is assumed, thereafter, that the second user 50 activates the second terminal device 500 at a timing t30 that comes after the timing t25, and performs an operation of receiving the second application APP2 in the second terminal device 500 at a timing t31 that comes after the timing t30. Therefore, the terminal device processing section of the second terminal device 500 performs an information reception process (step S412) in accordance with the flow of FIG. 9. Specifically, the terminal device processing section of the second terminal device 500 performs a process of reading transmission data supplied from the first user 40 stored in the second application server 600.

Thereafter, at a timing t32 that comes after the timing t31, the second application screen updating process (step S600) is performed so that screen information indicated by G1 is displayed in the second display section 510. When comparing the screen information G1 of FIG. 13 with the screen information E1 of FIG. 5, although header information indicated by G11 is the same as that indicated by E11 of FIG. 5 and message information indicated by G12 is the same as that indicated by E12 of FIG. 5, link information indicated by G13 is different from the link information indicated by E13 of FIG. 5. Specifically, the link information indicated by G13 is constituted by adding information indicated by G131 to the link information indicated by E13. The information indicated by G131 corresponds to “10202010112020” that is the time point information at the timing t10 described above with reference to FIGS. 11 and 12. That is, a deep link including time stamp information of the collection target apparatus 100 is transmitted from the first user 40.

As described above, the link information is generated by the first terminal device 400 that is a terminal device different from the second terminal device 500 serving as a terminal device. With this configuration, the same screen information may be shared with a user using a different terminal device, and in addition, the same screen information may be easily shared between different users.

Referring to FIG. 14, the flow of the process will be continued. At a timing t33 that comes after the timing t32, the second user 50 performs a deep link selection operation. Specifically, the link information that is the deep link indicated by G13 of FIG. 13 is selected. By this, the first application APP1 is activated in the second terminal device 500. The terminal device processing section of the second terminal device 500 performs the deep link reception process (step S222) and the share page request process (step S224) in accordance with the flowchart of FIG. 7. Specifically, the terminal device processing section performs a process of requesting the information processing system 300 to transmit display screen information corresponding to time stamp information indicated by G131 of FIG. 13. More specifically, although not illustrated in FIG. 14, the terminal device processing section performs the share page request process (step S224) on the processing section 320 through the communication section 310.

Thereafter, at a timing t40 that comes after the timing t33, the information processing system 300 performs a share page transmission process. Specifically, the processing section 320 performs a process of transmitting the display screen information corresponding to the time stamp information indicated by G131 of FIG. 13 to the terminal device processing section of the second terminal device 500 through the communication section 310.

Thereafter, the terminal device processing section of the second terminal device 500 performs the share page display process (step S232) in accordance with step S230 of FIG. 7. Then, at a timing t41 that comes after the timing t40, the first application screen updating process (step S300) illustrated in FIG. 6 is performed so that screen information indicated by F2 is displayed in the second display section 510. The screen information F2 is different from the screen information F1 illustrated in FIG. 5 and is the same as the screen information D1 illustrated in FIGS. 5 and 12.

As described above, the information processing system 300 of this embodiment further includes the storage section 330 that stores status history information that is history information of status associated information. Furthermore, the communication section 310 transmits display screen information of status information specified by time stamp information in the status history information to the second terminal device 500 that is a terminal device, based on the time stamp information specified by the first application APP1 that is an application of the first terminal device 400 that is a terminal device.

By this, even when users open the application in different timings, the same status associated information may be shared. Specifically, when the second user 50 activates the first application APP1 of the second terminal device 500 at the timing t41, the second user 50 may recognize content of the event based on the time stamp information specified by the first user 40 at the timing t10 that comes before the timing t41.

Furthermore, the method of this embodiment may be realized as the information provision system 10. That is, the information provision system 10 of this embodiment includes the information processing system 300, the first terminal device 400, and the second terminal device 500 serving as a terminal device. The first terminal device 400 transmits link information to the second terminal device 500. By this, the first terminal device 400 and the second terminal device 500 may share screen information associated with status associated information at the same time point.

Furthermore, although the description above is the example in which time stamp information included in the link information is shared, the method of this embodiment is not limited to this, and time stamp information may be shared using a push notification as a modification, for example. The push notification may be realized when the first application APP1 implements a push notification function.

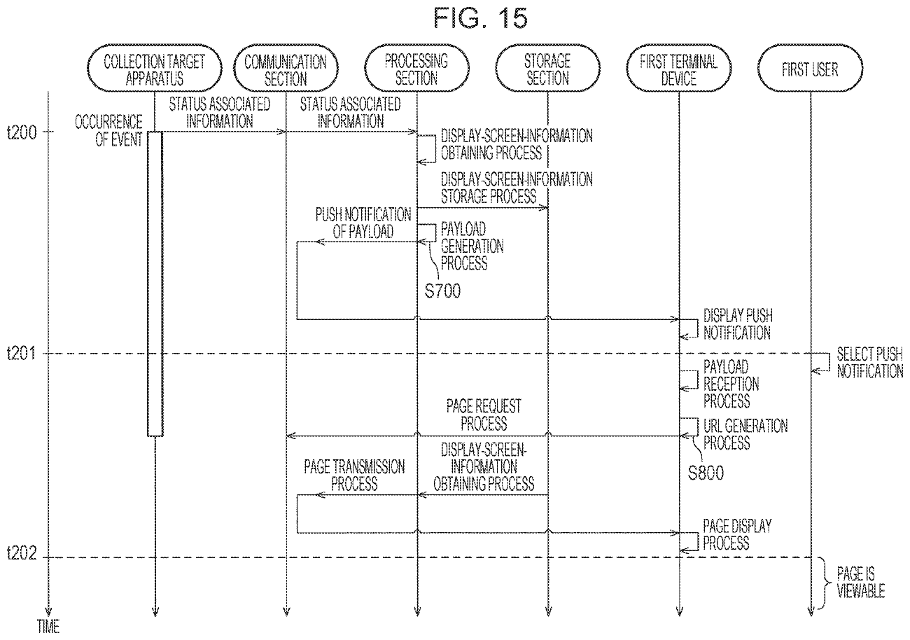

FIG. 15 is a diagram illustrating a flow of a process according to the modification. It is assumed that an event occurs at a timing t200 in the collection target apparatus 100. It is further assumed that the timing t200 is the same as the timing t100 of FIG. 5 and the timing t10 illustrated in FIGS. 11 and 12. It is further assumed that the event indicates an error similarly to FIGS. 3, 5, and 11. Furthermore, reference numerals of processes the same as those described above are omitted. Furthermore, although only the first user 40 and the first terminal device 400 are illustrated as representatives in FIG. 15, the same is true of other users and other terminal devices, such as the second user 50 and the second terminal device 500.

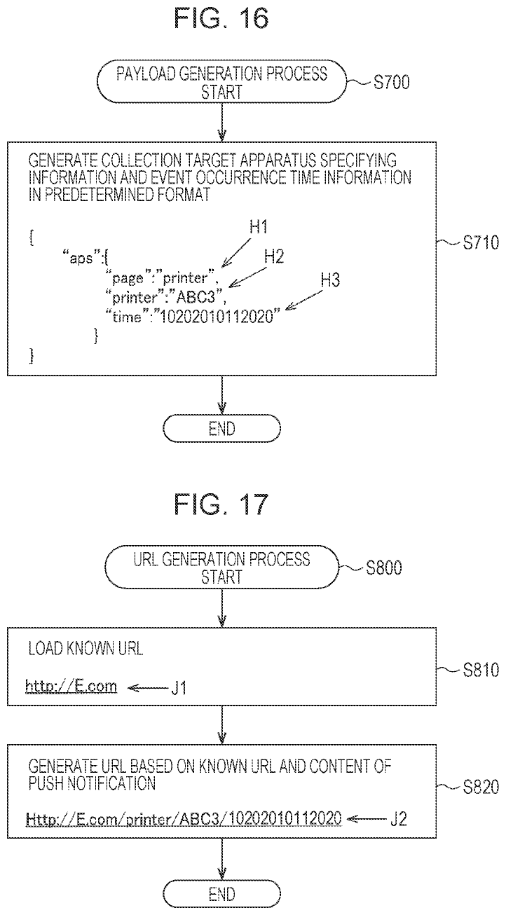

The processing section 320 performs a payload generation process (step S700) in addition to the display screen information generation process and the display screen information storage process similarly to FIG. 11. The payload generation process (step S700) will be described hereinafter with reference to FIG. 16. Thereafter, the processing section 320 performs a process of performing a push notification of a payload through the communication section 310. By this, although not illustrated, a push notification screen is displayed in the first display section 410.

When the first user 40 who recognizes the push notification screen selects the push notification at a timing t201 that comes after the timing t200, the terminal device processing section of the first terminal device 400 performs a payload reception process before performing a URL generation process (step S800). The URL generation process (step S800) will be described hereinafter with reference to FIG. 17.

The terminal device processing section of the first terminal device 400 performs a page request process on the processing section 320 through the communication section 310. The processing section 320 performs a screen display information obtaining process of obtaining screen display information from the storage section 330 and a page transmission process of transmitting a page to the terminal device processing section through the communication section 310.

Then the terminal device processing section of the first terminal device 400 performs a page display process, and a requested page may be viewed at a timing t202 that comes after the timing t201 onwards. Accordingly, although the event of the collection target apparatus 100 is terminated at a timing after the timing t201 and before the timing t202, the first user 40 may view the page associated with the event that occurred at the timing t200.

FIG. 16 is a flowchart of an example of the payload generation process (step S700) illustrated in detail. The processing section 320 generates information for specifying the collection target apparatus 100 and information on a time point when the event is generated in a predetermined format. Although the predetermined format is a JSON format as illustrated in FIG. 16, for example, an XML format or the like may be employed as long as the format supports an operating system (OS) implemented in the first terminal device 400. Examples of the information for specifying the collection target apparatus 100 include information indicated by H1 and H2 in FIG. 16. Furthermore, the information on the time point when the event occurs is information indicated by H3, for example, that is the same as described above. When the payload transmission process described above is performed, the push notification representing the information indicated by H1 to H3 is displayed in the first display section 410, although not illustrated. The information indicated by H1 and H2 represents information on a layer stored in the storage section 330, for example.

FIG. 17 is a flowchart of an example of the URL generation process (step S800) illustrated in detail. The terminal device processing section of the first terminal device 400 first performs a process of loading a known URL (step S810). The known URL means a URL stored in a ROM, not illustrated, of the first terminal device 400 when the first application APP1 is installed. The terminal device processing section performs a process of developing the URL in the RAM not illustrated. A URL indicated by J1 represents the top page indicated by A1 of FIG. 2 displayed by a browser of the first application APP1, for example.

Thereafter, the terminal device processing section of the first terminal device 400 performs a process of generating a URL based on the known URL and content of the push notification (step S820). Specifically, the terminal device processing section of the first terminal device 400 performs a process of generating a URL that specifies a directory in a layer lower than a directory indicating the top page using the information indicated by H1 in FIG. 16. Furthermore, the same process is performed using information indicated by H2 and information indicated by H3 so as to finally generate a URL indicated by J2. In this way, the URL may specify display screen information in a desired layer stored in the storage section 330 and request a desired page, and therefore, users including the first user 40 may view a screen of status associated information at a required timing.

As described above, the link information is transmitted from the communication section 310 to the terminal device by the push notification. Accordingly, since the information processing system 300 simultaneously transmits the push notification to individual users, the users may easily share screen information of the same status associated information without operations of the users.

As described above, the information processing system of this embodiment includes the communication section and the processor. The communication section is used to communicate with the collection target apparatus and the terminal device capable of using the application that manages and displays the status associated information of the collection target apparatus through the network. Furthermore, the communication section obtains status associated information including an event that occurs in the collection target apparatus. The processing section performs a process of generating display screen information of the status associated information that is displayed by the application activated when link information is selected in the terminal device and that is specified by the link information. Furthermore, the communication section transmits the display screen information generated by the generation process to the terminal device.

Accordingly, since the application is automatically activated by selecting the link information displayed in the terminal device, the user may omit activation of the application.

Furthermore, the storage section that stores the status history information that is history information of status associated information may be further included, and the communication section may transmit display screen information of status associated information specified by time stamp information in the status history information to the terminal device, based on the time stamp information specified by the application of the terminal device.

Accordingly, when the application is opened in different timings, status associated information at a certain time point may be recognized.

Furthermore, the link information may be information transmitted from the communication section to the terminal device by the push notification.

By this, the user may obtain the status information without user's operation.

Furthermore, the link information may be generated by another terminal device different from the terminal device.

With this configuration, the same screen information may be shared with a user using a different terminal device, and in addition, the same screen information may be easily shared between different users.

That is, the information provision system of this embodiment includes the information processing system described above, the first terminal device, and the second terminal device that is a terminal device. The first terminal device transmits link information to the second terminal device.

Furthermore, the program of this embodiment is the status associated information collected by the information processing system and causes the terminal device to execute a step of receiving link information for displaying display screen information of the status associated information including an event generated in the collection target apparatus and a step of activating the application specified by the link information. Furthermore, the activated application causes the terminal device to execute a step of receiving the display screen information from the information processing system and a step of displaying the display screen information.

Furthermore, the information processing method of this embodiment performs a process of communicating with the collection target apparatus and the terminal device capable of using the application that manages and displays the status associated information of the collection target apparatus through the network and a process of obtaining the status associated information including the event generated in the collection target apparatus. Furthermore, the information processing method of this embodiment performs a process of generating display screen information of the status associated information that is to be displayed by the application activated when link information is selected in the terminal device and that is specified by the link information and a process of transmitting the generated display screen information to the terminal device.

Note that, although this embodiment is described in detail as described above, those skilled in the art may easily understand that various modifications may be made without substantially departing from novelty and effects of the present disclosure. Accordingly, these modifications are included in the scope of the present disclosure. For example, a term described with a different term that has wider meaning or the same meaning at least once in the specification and the drawings may be replaced by the different term in any portion in the specification and the drawings. Furthermore, all combinations of the embodiment and the modifications are included in the scope of the present disclosure. Moreover, configurations and operations of the information processing system, the information provision system, the program, the information processing method, and the like are also not limited to those described in this embodiment and various modifications may be made.

What is claimed is:

1. An information processing system, comprising:
a communication section configured to perform communication through a network with a collection target apparatus and a terminal device that uses an application for managing and displaying status associated information of the collection target apparatus; and
a processing section, wherein
the communication section obtains the status associated information including an event that occurs in the collection target apparatus,
the processing section performs a process of generating display screen information of the status associated information that is displayed by the application activated when link information is selected in the terminal device and that is specified by the link information, and
the communication section transmits the display screen information generated by the generation process to the terminal device.

2. The information processing system according to claim 1, further comprising:
a storage section configured to store status history information that is history information of the status associated information, wherein
the communication section transmits, based on time stamp information specified by the application of the terminal device, display screen information of the status associated information specified by the time stamp information in the status history information to the terminal device.

3. The information processing system according to claim 1, wherein
the link information is transmitted by the communication section to the terminal device by means of a push notification.

4. The information processing system according to claim 1, wherein
the link information is generated by another terminal device that is different from the terminal device.

5. An information provision system comprising:
the information processing system set forth in claim 1;
a first terminal device; and
a second terminal device that is the terminal device, wherein
the first terminal device transmits the link information to the second terminal device.

6. An information processing method, comprising:
performing communication through a network with a collection target apparatus and a terminal device that uses an application for managing and displaying status associated information of the collection target apparatus;
obtaining the status associated information including an event that occurs in the collection target apparatus;
generating display screen information of the status associated information that is displayed by the application activated when link information is selected in the terminal device and that is specified by the link information; and
transmitting the display screen information to the terminal device.
